(19) United States
(12) Patent Application Publication
(10) Pub. No.: US 2016/0292618 A1
(43) Pub. Date: Oct. 6, 2016

(54) MANDATING TASKS AT RUN-TIME FOR CASE MANAGEMENT

(71) Applicant: International Business Machines Corporation, Armonk, NY (US)

(72) Inventors: Bala Siva C.S. Padarthi, Hyderabad (IN); Ranjeeth Pasupathi, Coimbatore (IN)

(21) Appl. No.: 15/081,984

(22) Filed: Mar. 28, 2016

Related U.S. Application Data
(63) Continuation of application No. 14/672,359, filed on Mar. 30, 2015.

(51) Int. Cl. G06Q 10/06

(52) U.S. Cl. CPC G06Q 10/063114

(57) ABSTRACT

A method for governing task completion. A unit of work to be completed is identified. The unit of work includes at least one task and a status of the task indicates that the task is optional. Additional information is retrieved that indicates at least one circumstance associated with the at least one optional task. It is determined whether the circumstance warrants promotion of the task to a status that indicates that the task is mandatory. In response to a determination that the circumstance warrants promotion, the task is promoted.

### BACKGROUND OF THE INVENTION

The present invention relates generally to the field of case management, and more particularly to mandating tasks to control case completion.

Dynamic Case Management (DCM), also known as Adaptive or Advanced Case Management (ACM), is a method of automating and streamlining of case processing both formalized and adhoc. It helps your business to more effectively and efficiently create or open cases, monitor their progress, drive cases to completion, and gain insight for decision, risk, and productivity management. Dynamic case management is more than BPM (business process management) or Content Management; the best of DCM that it is a combination of both these practices optimized for people-driven processes. DCM works on an adhoc basis to manage dynamic, unstructured processes. DCM can be especially effective for companies handling “untamed” business processes that lack structure. DCM's ultimate goal is helping such workers make faster, better and more accurate decisions.

### SUMMARY

Embodiments of the present invention provide a method to modify a necessity of task completion which includes identifying a unit of work to be completed that includes a task, wherein a status of the task indicates that the task is optional; retrieving a first additional information that indicates at least one circumstance associated with the task; determining whether the circumstance warrants promotion of the task to a status that indicates that the task is mandatory; and responding to a determination that the circumstance warrants promotion of the task to a status that indicates that the task is mandatory by promoting the task to reflect the status that indicates that the task is mandatory.

### BRIEF DESCRIPTION OF THE SEVERAL VIEWS OF THE DRAWINGS

FIG. 1 is a functional block diagram illustrating a case management environment, in accordance with an exemplary embodiment of the present invention.

FIG. 2 illustrates a flowchart of operational processes of a case management program, executing on a computing device within the environment of FIG. 1, in accordance with an exemplary embodiment of the present invention.

FIG. 3 depicts a block diagram of components of the computing device executing the case management program, in accordance with an exemplary embodiment of the present invention.

### DETAILED DESCRIPTION

Embodiments of the present invention recognize that a solution in any given case management system is designed by creating a set of solution parameters, a set of case types and a set of tasks within those case type all making use of the solution parameters. Tasks are the logical units of work. Apart from the underlying process workflow, the task includes a set of configurable properties. For example, whether the task is optional or mandatory, whether it is automatically launched or to be manually launched, and whether the task has any precondition to be satisfied before it can be launched etc. Among such configurable properties, the configuration parameter to make a task mandatory determines which among the available tasks are to be completed in order for the case to be deemed completed overall. When a case is deemed to be at the point of overall completion it means that the tasks associated with that case have been processed and otherwise completed to a point that satisfies a set of criteria or requirements that are used to determine whether the case has reached the point of overall completion. For example, in some embodiments, a case is completed, i.e., reached the point of overall completion, when all mandatory tasks have been completed for that case. With some case management systems, it is not possible to make a task mandatory at run-time, which leads to a situation in which a mandatory task is executed for all customers irrespective of the run-time data.

Some case management systems allow the mandatory and optional parameters to be configured during solution design. However, once configured, there is no way to change the mandatory and optional parameters at run-time. At the point of run-time, a given task is either mandatory or optional for its lifetime, irrespective of the customer case to which it belongs. As such, in these solutions, there is no way to make a task mandatory for a few cases and yet optional for the others. For example, consider a health insurance provider using case management system for insurance underwriting. Consider a special health review task, which is designed for stress related diseases. This task is mandatory for customers who have selected yes for high stress. In this example, such information is based on answers to a questionnaire from which the provider identifies the customer's perceived level of stress. For low stress customers, this task optional, since performing the task for low stress individuals is not a cost effective use of resources. In various embodiments, for such tasks, run-time input is used to determine whether those tasks are mandatory or optional.

Embodiments of the present invention recognize that with some solutions, task(s) that are not mandatory based on run-time data are executed for all cases, which increase the rigidity of the entire case management system. Embodiments of the present invention recognize that in some solutions caseworkers act on tasks that are optional for a customer and drive them to completion instead of using that time to work on mandatory tasks as indicated by the run-time data. Embodiments of the present invention recognize that the time to complete a given case is increased if caseworkers are completing optional tasks along with completing mandatory tasks.

Embodiments of the present invention provide usage of run-time data to control the status of tasks as being either mandatory or optional. Embodiments of the present invention provide increased flexibility of the case management system. Embodiments of the present invention provide increased efficiency in the usage of time by caseworkers by reducing the number of optional tasks being completed. Embodiments of the present invention provide reduced turn-around time for case completion.

The present invention will now be described in detail with reference to the Figures.

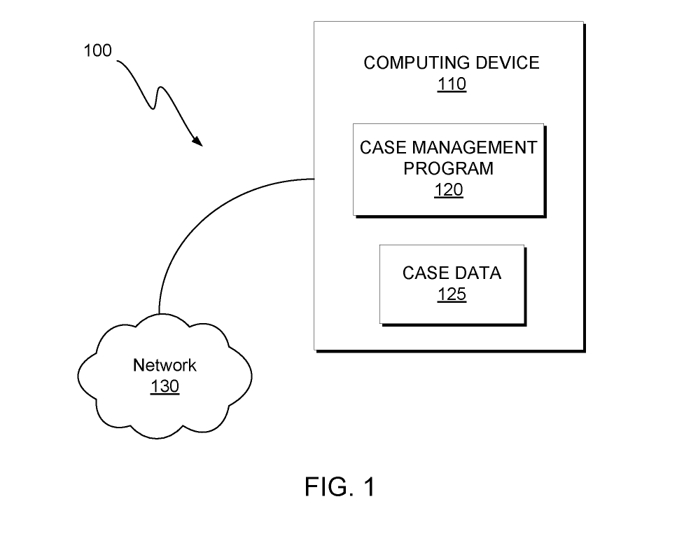

FIG. 1 is a functional block diagram illustrating case management environment, generally designated 100, in accordance with one embodiment of the present invention. Case management environment 100 includes computing device 110 connected over network 130. Computing device 110 includes case data 125 and case management program 120.

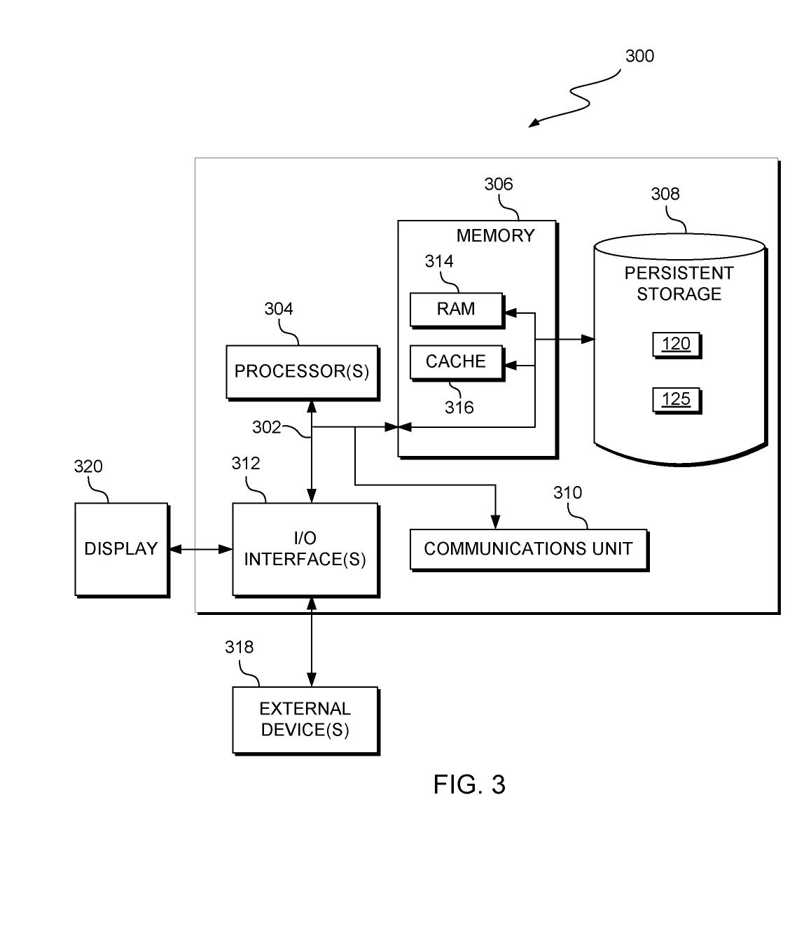

In various embodiments of the present invention, computing device 110 is a computing device that can be a standalone device, a server, a laptop computer, a tablet computer, a netbook computer, a personal computer (PC), or a desktop computer. In another embodiment, computing device 110 represents a computing system utilizing clustered computers and components to act as a single pool of seamless resources. In general, computing device 110 can be any computing device or a combination of devices with access to case data 125 and case management program 120 and is capable of executing case management program 120. Computing device 110 may include internal and external hardware components, as depicted and described in further detail with respect to FIG. 3.

In this exemplary embodiment, case data 125 and case management program 120 are stored on computing device 110. However, in other embodiments, case data 125 and case management program 120 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between computing device 110, case data 125 and case management program 120, in accordance with a desired embodiment of the present invention.

In some exemplary embodiments, a task within a case management system is configurable to be either mandatory or optional during run-time. This configuration is not completed during design time but rather during run-time based on run-time data. Once a task is made mandatory, it is required to be executed in order for the case to reach completion. As such, there may be a reduction in the amount of time spent on work items pertaining to optional tasks.

A process is described herein where a task is configurable to be either mandatory or optional based on a rule or a condition on case properties at run-time. In some cases and embodiments, configuring a case to be either mandatory or optional, based on run-time parameters, increases the flexibility of such a case management system. This flexibility can result in a reduction in the resources needed to bring the case to completion, i.e., a point of processing at which the case is determined to be completed based on a set of criteria.

For example, a health insurance provider is using case management program 120 for insurance underwriting. Consider a special health review task that is designed for environmental related diseases based on, for example, risk factors. In general, a risk factor, as used herein, is a variable associated with an increased risk of disease or infection. Risk factors or determinants are correlational and not necessarily causal, because correlation does not prove causation. For example, being of a particular age group cannot be said to cause a particular disease, but individuals in that are in that age group may have a higher rate of the disease because they are less likely to have an immunity to the disease. Statistical methods are frequently used to assess the strength of an association and to provide causal evidence (for example in the study of the link between a toxin and a disease). Statistical analysis along with the biological sciences can establish that risk factors are causal. Some prefer the term risk factor to mean causal determinants of increased rates of disease, and for unproven links to be called possible risks, associations, etc. Sometimes, determinant is also used, being a variable associated with either increased or decreased risk. A risk marker is a variable that is quantitatively associated with a disease or other outcome, but direct alteration of the risk marker does not necessarily alter the risk of the outcome. Case management program 120, has access to a library of medical knowledge (included as part of case data 125) that includes risk factors, determinants and risk markers as well as a list of one or more searches for additional information to be performed if a particular risk factor is identified.

In case management program 120, the task being processed has an underlying workflow that is configured to verify the health history of the customer for specific environmental related ailments. As such, case management program 120 is configured to query the customer and obtain additional health test reports to be presented for verification. In some embodiments, the output of this process is a recommendation, which includes, in some cases and embodiments, preconditions for forthcoming tasks. As such, based upon the recommendation, further tasks are executed.

Continuing with the above example regarding the health insurance provider using case management program 120 for insurance underwriting, a first task is deemed mandatory for customers who have selected yes for exposure to, for example, hazardous chemicals in the environment (or based on answers to a questionnaire, the provider identifies the type of employment that includes a high probability of such an exposure). For some customers, this task is optional because there is a reduced chance of environmental related diseases (e.g., administrative workers at facilities that may have not been directly exposed to the hazardous materials, however the facilities had hazardous materials on-site). However, for the cases where customers are at risk for the environmental related disease, this task is not listed as optional, instead the task is mandatorily executed. While the execution of the task for the “at risk” cases increases the overall time required for case completion, there is a reduction in the overall time required for case completion for all cases since those cases that are deemed to be not “at risk” do not have the task mandatorily executed.

In one embodiment, a system designer configures case management program 120 prior to deployment. In one embodiment, a configuration option called “Decide at run-time” is provided for tasks in addition to “mandatory” and “optional” parameters for tasks. When the “Decide at run-time” option is selected, the system designer of case management program 120 is presented with a wizard to design the criteria for mandating the task, which is then provided, thereby configuring case management program 120 prior to deployment. In some embodiments, the criteria is a condition based on the case and solution parameters. For example if an “at risk for environmental diseases” prompt has a drop down with “Yes” or “No” options, then the designer can create, as the condition, a logical argument such as [When “at risk for environmental diseases” is “True”]. In some embodiments, the criteria are one or more business rules from a Business Rule Management System (BRMS), which can be written based, in part, on the case properties. In some embodiments, the criteria are a combination of a simple condition and a business rule. Once the task is configured to be mandated at run-time, for example, when case management program 120 determines that a case instance has been created, based on the initial list of properties or changes to the properties of the case, case management program 120 can promote the task into the list of mandatory tasks associated with that case. In another embodiment, case management program 120 is configured to determine whether a task is to be changed from a “mandatory” to an “optional” status. In some scenarios and embodiments, case management program 120 determines whether to change the status of a task from “mandatory” to an “optional” status based on the results of an analysis of additional information similar to the process used by case management program 120 when determining whether to change the status of a task from an “optional” to a “mandatory” status.

In this exemplary embodiment, case data 125 includes both historical records as well as databases for use by case management program 120 for text analytics. Such databases include information such as synonyms and background information regarding multiple subjects. For example, such data includes statistics for hazards associated with exposure to various substances that are cross-referenced and associated with various occupations.

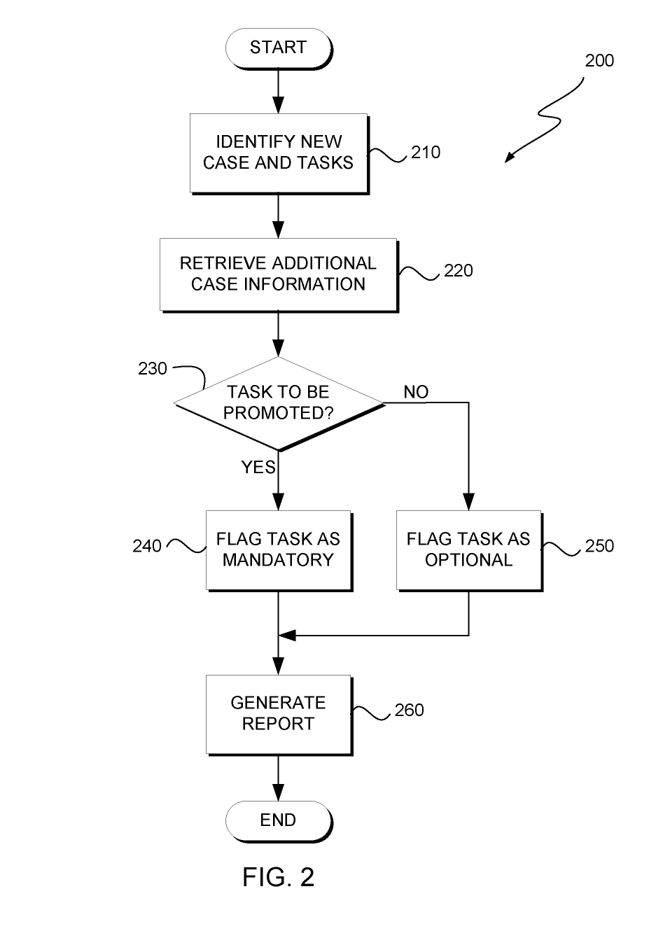

FIG. 2 illustrates a flowchart, 200, of operational processes of case management program 120, on a computing device within the environment of FIG. 1, in accordance with an exemplary embodiment of the present invention.

In step 210, case management program 120 identifies a new case as well as the tasks associated with that case, which includes currently mandatory tasks and optional tasks. In some embodiments, a given task or group of tasks are included as part of a unit of work as sub-tasks for a task included in the case. For example, a unit of work for a case is a general medical assessment. As such, the unit of work includes a series of “standard” medical assessments and procedures that are included in a general medical assessment, such as a test for blood pressure and palpation of the abdomen of the patient. In another unit of work, a more detailed blood screening is indicated. As such, this unit of work includes the drawing of several vials of blood (i.e., blood samples) in various vacuum tubes (vials) as well as the assessments to be performed on each sample of blood. In one embodiment, case management program 120 analyzes each unit of work to identify the specific tasks included in each unit of work. In one embodiment, case management program 120 is configured for use in a medical facility to facilitate the assessment and treatment of patients and processing of their associated cases (including paperwork, records, ordering tests etc.). For example, case management program 120 receives a case identification number that is associated with a new case Z for patient X. Case management program 120 uses the case identification number to access a list of tasks that are associated with new case Z, which includes both currently mandatory tasks and optional tasks based on initial settings for tasks in accordance with the configuration of case management program 120. In this example, case management program 120 includes a list of “standard” mandatory tasks, such as basic “physical check-up” tasks, as well as a list of optional tasks such as specific medical tests, and treatments etc.

In this embodiment, in step 220, case management program 120 is configured to respond to the creation of or identification of a new case for a patient by retrieving additional information about the patient that is identified by the case. As such, case management program 120 identifies the patient (based on a form of identification provided by the patient or based on an identify of a patient associated with the case), retrieves additional information indicating the properties of the case, and analyses that information to determine whether a given optional task is to be promoted to the mandatory task list. For example, case management program 120 uses a case identification number to access archived medical records for patient X included in case data 125. The retrieved records indicate a medical history (via medical records) and a variety of questionnaires that have been filled out by patient X, which indicate a work history, a family medical history, and non-work related records of the patient. Case management program 120 applies techniques for text analytics and natural language processing to the data records to identify key words and other indications that are then applied to a set of rules included in case management program 120. These rules are rules that were preconfigured prior to the activation of case management program 120 to process cases. The rules dictate whether a given optional task is to be promoted to the mandatory task list. In some instances, case management program 120 simply adds the determined information to the rules as variables. Case management program 120 then analyzes whether or not the variables yield a result, via the rule, that indicates that the task is to be promoted from an optional to a mandatory status. For example, case management program 120 analyzes a work history questionnaire that was filled out by the patient. Analysis of the work history identifies the key words “occupation:” followed by “heavy metal refinery”. Case management program 120 accesses case data 125 and identifies that the occupation “heavy metal refinery” is associated with an “environmental hazard” warning. As such, case management program 120 enters “heavy metal” and “environmental hazard” into a rule included in case management program 120. Case management program 120 also searches the medical records included in case data 125 and determines that patient X has never been tested for heavy metal exposure, this information is also evaluated using the rule included in case management program 120. As a result, the rule generates a result indicating that a blood test for heavy metal poisoning is to be promoted from an optional status to a mandatory status.

In some embodiments and scenarios, case management program 120 is configured to determine whether sufficient information is available in order for a rule to be used to determine whether a task is to be promoted. In such embodiments, if case management program 120 determines that sufficient information is not available, then case management program 120 determines that further additional information is needed and adds one or both of medical tests, or questionnaires as mandatory tasks to be completed for the unit of work. In some cases, case management program 120 conducts searches for further additional information based on the information that was retrieved. For example, case management program 120 identifies that patient Z worked for company P. In response, case management program 120 accesses the work records of company P and identifies the role that Patient Z filled while they were employed there. In general, in such embodiments and scenarios, case management program 120 is configured to apply a variety of search and analysis techniques in order to retrieve the additional information needed to in order to make a determination as to whether a rule indicates that a task is to be promoted. In other words, case management program 120 is configured to retrieve the additional information that is used by a given rule as variables when determining whether a rule indicates that a task is to be promoted. In some cases, this includes additional testing being ordered for the patient, in other cases, this may include additional searches and analysis of information included in databases.

In some embodiments, case management program 120 includes additional programming that provides the functionality to perform statistical analysis based on the analysis of the data included in case data 125. In some cases, a given criteria or condition must meet a specific threshold in order for a rule to yield a determination that the task is to be promoted. For example, case management program 120 identifies that patient X was employed at the heavy metal refinery for two weeks and no chemical spills or other types of undesired toxin exposure were recorded that involved patient X. As such, case management program 120 applies statistical analysis algorithms to determine the probability that patient X was exposed to a level of heavy metals (based on a threshold for exposure) that pose a significant danger to the wellbeing of patient X, e.g., a degree of danger posed by an exposure that is above the threshold. In this case, case management program 120 analyses the average heavy metal particulate content of the air that was likely inhaled by patient X and extrapolates the most probable amount of heavy metal ingested by patient X based on that analysis. Case management program 120 then factors this data into the analysis using the rule to determine whether a given optional task is to be promoted to the mandatory task list.

In determination step 230, case management program 120 identifies whether a given optional task is to be promoted to the mandatory task list based on a result of the analyses of the information indicating the properties of the case (e.g., based on the result of the analysis using case data 125 and the rule of step 220). If the task is to be promoted (determination step 230, YES branch), then in step 240 case management program 120 flags that task as being mandatory for completion if that task is not already so flagged. If the task is not to be promoted (determination step 230, NO branch), then, in step 250, case management program 120 flags that task as being optional for completion if that task is not already so flagged. This process is repeated for each of the optional tasks. Once all of the optional tasks have been analyzed and flagged as either optional or mandatory, case management program 120 generates a report indicating which tasks are mandatory and optional for case completion, in step 260.

In some embodiments, the promotion of an optional task to a mandatory status initiates a full reassessment of previously analyzed tasks. In some scenarios, the promotion of a given task to a mandatory task dictates or would otherwise lead to the promotion of other tasks as well, as would be determined by the rules included in case management program 120.

FIG. 3 depicts a block diagram, 300, of components of computing device 110, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Case data 125 and case management program 120 are stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of network 130. In these examples, communications unit 310 includes one or more network interface cards. Communications unit 310 may provide communications through the use of either or both physical and wireless communications links. Case data 125 and case management program 120 may be downloaded to persistent storage 308 through communications unit 310.

I/O interface(s) 312 allows for input and output of data with other devices that may be connected to computing device 110. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., case data 125 and case management program 120, can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that some term(s) used herein may be subject to trademark rights in various jurisdictions throughout the world and are used here only in reference to the products or services properly denominated by the marks to the extent that such trademark rights may exist.

What is claimed is:

1. A method of modifying a necessity of task completion, the method comprising:
identifying, by one or more processors, a unit of work to be completed that includes a task, wherein a status of the task indicates that the task is optional;
retrieving, by the one or more processors, a first additional information that indicates a circumstance associated with the task;
determining, by the one or more processors, whether the circumstance warrants promotion of the task to a status that indicates that the task is mandatory; and
responsive to a determination that the circumstance warrants promotion of the task to a status that indicates that the task is mandatory, promoting, by the one or more processors, the task to reflect the status that indicates that the task is mandatory.

2. The method of claim 1, the method comprising:
responsive to identification of a new case for a patient of a medical facility, retrieving, by the one or more processors, a unit of work that is associated with that new case; and
analyzing, by the one or more processors, the unit of work to identify the task.

3. The method of claim 1, the method comprising:
responsive to identification of a new case for a patient of a medical facility, retrieving, by the one or more processors, the first additional information about a patient that is identified by the case, and
analyzing, by the one or more processors, the first additional information using natural language processing to identify the at least one circumstance associated with the task that has a status of optional.

4. The method of claim 3, the method comprising:
retrieving, by the one or more processors, an identity of the patient;
performing, by the one or more processors, a search of medical records and records indicating a work history of the patient; and
analyzing, by the one or more processors, retrieved medical records and records indicating the work history of the patient to identify circumstances that are variables a first set of rules that indicate whether the task is to be promoted to a status that indicates that the task is mandatory.

5. The method of claim 1, the method comprising:
determining, by the one or more processors, whether a circumstance meets one or more thresholds in accordance with a second set of rules that indicate whether the task is to be promoted to a status that indicates that the task is mandatory.

6. The method of claim 1, the method comprising:
responsive to a result of a rule indicating the task is mandatory, changing, by the one or more processors, the status of the task to indicate that the task must be completed in order for the unit of work to meet one or more requirements that dictate whether the unit of work is completed, wherein the rule is included in a third set of rules that indicate whether the task is to be promoted to a status that indicates that the task is mandatory.

7. The method of claim 1, the method comprising:
responsive to a determination that a second additional information is needed in order to determine whether the circumstance warrants promotion of the task to a status that indicates that the task is mandatory, adding, by the one or more processors, one or both of a medical test and a questionnaire as mandatory tasks to be completed for the unit of work.
